(19) United States
(12) Patent Application Publication
(10) Pub. No.: US 2013/0203089 A1
(43) Pub. Date: Aug. 8, 2013

(54) Filtered Adapter for Pipettors

(71) Applicants: James P. Wingo, Peachtree City, GA (US); Tim Meredith, Peachtree City, GA (US); Edward M. Kaucic, Newman, GA (US); Timothy Martin, Newnan, GA (US); Guoqiang Mao, Peachtree City, GA (US)

(72) Inventors: James P. Wingo, Peachtree City, GA (US); Tim Meredith, Peachtree City, GA (US); Edward M. Kaucic, Newman, GA (US); Timothy Martin, Newnan, GA (US); Guoqiang Mao, Peachtree City, GA (US)

(73) Assignee: Porex Corporation, Fairburn, GA (US)

(21) Appl. No.: 13/825,597

(22) PCT Filed: Sep. 21, 2011
(86) PCT No.: PCT/US2011/052560

§ 371 Date: Mar. 22, 2013

Related U.S. Application Data
(60) Provisional application No. 61/385,716, filed on Sep. 23, 2010.

(51) Int. Cl. B01L 3/02

(52) U.S. Cl. CPC B01L 3/021
USPC 435/7.92; 422/535; 435/287.2; 436/165

(57) ABSTRACT

The present invention relates to an adapter containing a filter that can be used with pipetting devices, particularly robotic pipetting devices, to efficiently connect the pipetting device to pipette tips with minimal distortion of the pipette tip. The present invention also relates to a process and a system of using an adapter containing a filter that can be used with pipetting devices, particularly robotic pipetting devices, to assemble the adapter together with an unfiltered pipette tip on the site of application. The adapter and pipette tip are each stackable for saving space at the work station.

### FIELD OF THE INVENTION

The present invention relates to a stackable adapter containing a filter that can be used with pipetting devices, particularly robotic pipetting devices, to connect the pipetting device to the pipette tip, and systems and methods for accomplishing this connection.

### BACKGROUND OF THE INVENTION

Robotic pipetting devices, often called liquid handling devices, are used in high throughput applications to automatically pipette desired fluid volumes into or out of receptacles such as cell culture plates, incubation tubes, assay tubes and various other receptacles. The size of pipette tips that contain filters and are held in a rack presents problems with the volume of space they occupy since it is difficult to stack such racks. Valuable storage space and bench space are obligated to accommodate such pipette racks.

What is needed is a system and method that permits pipette tips with or without filters to be stacked together in a rack in order to decrease wasted space so that automated and manual pipetting devices may efficiently engage one end of an adapter containing a filter and place the other end of the adapter in a pipette tip in the rack.

What is also needed is a system and method that permits a plurality of adapters containing a filter to be stacked together in a rack in order to decrease wasted space so that automated and manual pipetting devices may efficiently engage one end of the adapter containing a filter and place the other end of the adapter in a pipette tip during automated or manual pipetting operations.

### SUMMARY

The present invention provides a system and method that permits racks of adapters with filters and racks of pipette tips with or without filters to be stacked separately in order to decrease wasted space so that automated and manual pipetting devices may efficiently engage one end of an adapter containing a filter and place the other end of the adapter in a pipette tip. These adapters may be stacked in a single rack or placed in multiple racks that may be stacked so that automated and manual pipetting devices can simultaneously engage a plurality of adapters containing filters for placement in a plurality of pipette tips without filters.

The present invention also provides novel adapters for use in automated and manual pipetting operations. These adapters may be stacked in a rack. In one embodiment, these adapters comprise deformable walls surrounding a lumen, preferably plastic walls, and a filter placed in the lumen of the adapter so as to span the width of the lumen and form a barrier to aerosols and fluids. In different embodiments, the deformable walls are made of non-porous plastic or rubber.

The present invention saves space by permitting adapters to be stacked on top of each other in a rack or by permitting racks of stacked adapters with filters to be stacked on top of each other. The present invention also saves laboratory and bench top space by permitting pipette tips with or without filters to be stacked on top of each other in a rack. These separate stacks of adapters and pipette tips are employed in a method and system for robotic pipetting operations. The net effect of this system is that use of laboratory and research space is greatly enhanced by decreasing the amount of space occupied by such racks.

Since robotic liquid handling devices can run at high speed and perform numerous pipetting operations in a short period of time, robotic liquid handling devices may require large quantities of pipette tips to operate. Delivering pipette tips to the robotic liquid handling device in a fast and precise manner can be labor intensive. Failed to deliver the pipette tips to the robotic liquid handling devices may result in expensive assay failures. The present invention can reduce the labor requirement of supplying the pipette tips to the robotic machines by putting more pipette tips within the accessible range of robotic arms and also reduce assays failure caused by lack of pipette tips accessible to the robotic liquid handling device.

The present system and method also enhance the efficiency of placing an adapter containing a filter into a pipette tip through the use of automated and manual pipetting devices. These automated and manual pipetting devices can simultaneously engage a plurality of adapters and insert them into a plurality of pipette tips. The use of this efficient and reproducible system and method facilitates pipetting operations, particularly in high throughput situations. Pipetting devices are also called liquid handling devices in this application and the terms are used interchangeably.

Another benefit of this invention is that the operator of the automated pipetting device can select filter protection or no filter protection. If an operator of the automated pipetting device needs to protect against aerosol droplets from contaminating the pipetting device, the operator can program the computer in the automated pipetting device to control the arm or pipetting barrel to engage the adapter containing a filter and place it into a pipette tip. If in some steps, the pipetting protocols do not require aerosol protection, the operator can program the computer in the pipetting device to skip the adapter so the arm or pipetting barrel directly engages an unfiltered pipette tip. This significantly reduces the costs associated with such pipetting functions.

The present invention provides an additional benefit in overcoming the challenge to insert a relatively rigid filter into a long pipette tip. Placing a filter into an injection molded pipette tip at the correct location and providing a good seal between the filter and inner wall of the pipette tip is an engineering challenge, especially with high speed manufacturing processes. This requires precise clearances for the size and shape of the injection molded pipette tips and the molded filter parts. It also requires the rigidity and uniformity for injection molded pipette tips and the devices that hold them (e.g., racks, trays or container boxes) to withstand the pressure applied to the individual pipette tip and the rack holding the pipette tips. An inadequate insertion force may cause variation in the seals between the filter and pipette tip wall and result in aerosols passing through to the pipetting device during the pipetting event. Inadequate insertion force also may cause filters to fall off during the process of moving filters to desired locations to aspirate or eject a fluid. If insertion forces are too great, distortion of the pipette tip may occur and result in variation in the amount of liquid that is drawn into the pipette tip or expelled from it, causing errors in assays or increasing variability in biological or diagnostic tests. The adapters of the present invention are short, generally less than 1 inch, and may be less than half an inch. These adapters facilitate the insertion of an adapter containing a filter into a pipette tip.

The present system and method facilitates the insertion of an adapter containing a filter into a pipette tip to form a unit that protects against passage of aerosol droplets into the pipetting device during a pipetting event. This assembly process is easier and more reproducible than the process for inserting filters into pipette tips, particularly long pipette tips. The sizes and diameters for adapters are much easier to control during the injection molding process compared to long pipette tips. This adapter can easily be slipped onto a pipetting device and into or onto a pipette tip with little distortion of the size of the pipette tip. The adapters may also contain a circumferential ridge on the outer wall or inner wall of the adaptor for engagement with a circumferential groove or indentation on the inner wall or outer wall, respectively, of the pipette tip. These adapters containing filters can be stacked in a rack, thereby saving valuable bench space in a clinical or research laboratory. Further, the pipette tips without filters can be stacked in another rack, thereby saving additional valuable bench space.

### BRIEF DESCRIPTION OF THE FIGURES

FIG. 1 illustrates a stackable adapter with a solid wall and a porous filter located at a mid-point of the adapter, wherein the wall of the adapter may be plastic or rubber.

FIG. 2 illustrates a stackable adapter with a solid wall and a porous filter located near one end of the adapter, wherein the wall of the adapter may be plastic or rubber.

FIG. 3 illustrates two adapters. A stackable porous adapter is shown in FIG. 3A. Shown in FIG. 3B is a stackable porous adapter with a solid seal for contacting the pipette tip. FIG. 3C shows a stack of 2 stackable adaptors shown in FIG. 3B.

FIG. 4 is a schematic representation of a single adapter with a filter located within the adapter (top) and three adapters stacked together (bottom).

FIG. 5 is a schematic representation of a single adapter with a filter located at one end of the adapter and extending beyond that end (top) and three such adapters stacked together (bottom).

FIG. 6 is a schematic representation of a side view and a cross sectional view of an adapter which is tapered for optimal fit into a pipette tip. Dimensions are in inches unless otherwise specified.

FIG. 7 is a schematic representation of a side view and a cross sectional view of a tapered adapter inserted into a pipette tip. Dimensions are in inches unless otherwise specified.

FIG. 8 is a schematic representation of a side view and a cross sectional view of a tapered adapter containing a filter inserted into a pipette tip. Dimensions are in inches unless otherwise specified.

FIG. 9 illustrates a pipette probe or barrel of a pipetting machine engaged in a solid walled adapter containing a porous filter, wherein the adapter is engaged in a pipette tip. The probe engages the adapter and inserts it into the pipette tip using an interference fit. The pipetting device moves air through the adapter and pipette tip to draw fluid into the pipette tip or expel fluid from the pipette tip during a pipetting event. The pipetting device can eject the adapter and pipette tip after the pipetting event is finished.

FIG. 10 is a schematic representation of an adapter with a circumferential ridge on its outer wall which engages a ledge on the inner wall of a pipette tip when the adapter is placed into the pipette tip in a press fit design.

FIG. 11 is a schematic representation of an adapter with a circumferential ridge on its outer wall which engages a circumferential groove on the inner wall of a pipette tip when the adapter is placed into the pipette tip in a snap fit design.

FIG. 12 is a schematic representation of one embodiment of the operation of the system for robotic automated pipetting using the filtered adapters of the present invention.

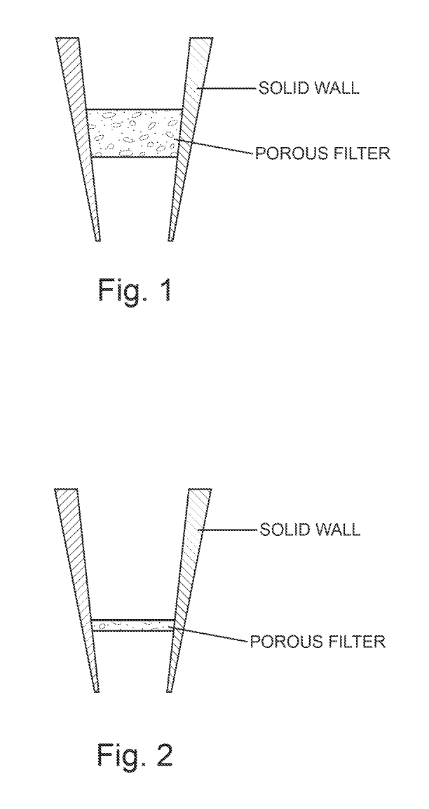

### DETAILED DESCRIPTION

The present invention provides adapters that are useful in efficient pipetting operations. These adapters provide an interface between pipetting devices and pipette tips. The present invention provides a system and method that permits racks of adapters with filters and racks of pipette tips with or without filters to be stacked separately in order to decrease wasted space so that automated and manual pipetting devices may efficiently engage one end of an adapter containing a filter and place the other end of the adapter in a pipette tip. These adapters may be stacked in a rack or kept in racks that may be stacked so that automated and manual pipetting devices can simultaneously engage a plurality of adapters containing filters for placement in a plurality of pipette tips without filters.

In one embodiment, this invention provides an adapter containing a filter that can retain fluid or aerosolized fluids. The filter can be a sintered porous plastic filter, a fiber filter, a screen, a membrane, a carbon nanotube filter, a metal filter, a ceramic filter or a combination thereof. In another embodiment, this invention provides a system and a method for efficient and reproducible assembly of adapters containing filters onto a pipetting device and then into a pipette tip using automated or robotic pipetting devices that can simultaneously perform multiple pipetting events. In another embodiment, this invention provides a system and a method for efficient and reproducible assembly of adapters containing filters onto a pipetting device and then into a pipette tip using manual pipetting devices that can simultaneously perform multiple pipetting events. Following the pipetting event, the pipette tip or the combined adapter and pipette tip may be disposed by ejection from the pipettor.

### Adapter

In one embodiment, this invention provides a short plastic adapter with an aerosol retaining porous media inside the adapter. The adapter has two openings: a first opening for connecting to a suction device, such as a pipetting barrel or arm of a manual pipetting device or a robotic pipetting device; and a second opening for connecting to a disposable pipette tip. In one embodiment the length of the adapter is less than 1 inch.

In one embodiment the adapters can be stacked on top of each other in a single rack, and the stacked height is significantly shorter than the total height of all the individual adapters in the stack.

In another embodiment the adapters can be stacked on top of each other in more than one rack, and the stacked height of the racks is significantly shorter than the total height of all the individual adapters in the stack.

In one embodiment, an adapter comprises a housing and a porous filtration medium. The adapter has a first end and a second end. In one embodiment, the adapter comprises a housing with a first opening on one end and a second opening on the other end. The housing contains a filtration medium which contacts the inner walls of the housing. In this embodiment, the wall of the housing is non-porous so that leakage of air is minimized during aspiration of air through the porous medium into the pipetting device or passage of air through the porous medium into the pipette tip. The filtration medium may be located at any position between the first and second ends of the adapter. In another embodiment, the filtration medium may be located at the first opening or at the second opening. In yet another embodiment, the filtration medium may extend beyond the first opening or the second opening.

Assembly of a filter in the adaptor is carried out in a similar manner to the assembly of a pipette and filter. Using a vibratory bowl or similar part feeding equipment, pipette filter plugs are fed through a dispense system where the plugs are singularly placed into the pipette tip and inserted to the proper depth with a mechanical punch. This action can be carried out for an individual pipette tip or for an entire well (96, 384, or any other number of tips contained in the well). This action may occur one pipette at a time or simultaneously for numerous pipette tips. Alternatively, pipette filter plugs can be manually rolled over an insertion tray where one plug is positioned in each hole. A mechanical insertion device is used to punch the plugs through the insertion tray into the receiving pipette tip to the proper depth.

In one embodiment, the first end of the adapter contains a first opening used to reversibly receive the barrel of the pipetting device which will draw air up through the filtration medium in the adapter or push air down through the filtration medium in order to draw fluid into the pipette tip or expel fluid from the pipette tip. A second end of the adapter is inserted into the pipette tip. The second end may have an opening and/or the second end may contain the filtration medium. In one embodiment, a portion of the second end comprises a porous medium that engages the inner walls of the pipette tip. In this embodiment, the first end of the housing is non-porous so that leakage of air is minimized during aspiration of air through the porous medium into the pipetting device or passage of air through the porous medium into the pipette tip. In another embodiment, a portion of the second end comprises a porous medium contained within a housing that engages the outer walls of the pipette tip.

In one embodiment, the second end of the adapter is designed to engage pipette tips of different sizes and can thereby act as a universal adapter. In one embodiment, this can be achieved by modulating the taper of the second end of the adapter.

In another embodiment, the first end of the adapter is designed to engage different pipetting devices of different sizes and can thereby act as a universal adapter.

In yet another embodiment, the first end of the adapter is designed to engage different pipetting devices of different sizes and the second end of the adapter is designed to engage pipette tips of different sizes and can thereby act as a universal adapter.

In another embodiment the adapter does not have a housing and the porous aerosol retention media also functions to contact the pipetting device and the pipette tip. In one embodiment, the porous aerosol retention media is a molded part with two ends: one end is connected to a robotic pipetting device and the other end to the pipette tip. In one embodiment, both ends of the adapter can be porous, provided a region of the adapter is solid to provide a location for application of a seal, such as an O-ring, to prevent leakage of air during aspiration of liquid into the reservoir of the pipette tip or during the expelling of the of liquid from the reservoir of the pipette tip. In another embodiment, the adapters may contain a circumferential ridge on the outer wall of the adaptor for engagement with a circumferential groove or indentation on the inner wall of the pipette tip. In another embodiment, the adapters may contain a circumferential ridge on the inner wall of the adaptor for engagement with a circumferential groove or indentation on the outer wall of the pipette tip. This arrangement provides a good locking fit between the adapter and the pipette tip, wherein the distance of insertion of the adapter on the arm of the pipetting device into the pipette tip can be programmed into the computer of the automated pipetting device.

### Composition of Adapters

The housing may be made by injection molding or compression molding processes, and may be molded plastic, molded rubber, or molded elastomers. In one embodiment, rubber materials may be polyisoprene or polybutadiene based materials. Several different materials may be used to make the housing. These include, but are not be limited to: polypropylene, polyethylene, silicone, polyvinylchloride (PVC), and thermoplastic elastomers (TPE). TPEs are styrenic block copolymers, polyolefin blends, elastomeric alloys (TPE-v or TPV), thermoplastic polyurethanes, thermoplastic copolyester and thermoplastic polyamides. Examples of TPE products in the block copolymers group include but are not limited to Arnitel (DSM), Engage (Dow Chemical), Hytrel (Du Pont), Kraton (Shell chemicals), Pebax (Arkema), Pellethane, Riteflex (Ticona), and Styroflex (BASF). Elastomer alloys are commercially available and include but are not limited to: Alcryn (Du Pont), Dryflex, Evoprene (AlphaGary), Forprene, Geolast (Monsanto), Mediprene, Santoprene and Sarlink (DSM).

The porous filtration media may be made by sintering or by pultrusion of fiber materials. The sintering process is disclosed in U.S. Pat. No. 6,808,908 and the porous fiber pultrusion process is disclosed in US Patent Application Publication No: US2003/0211799. The porous filtration media may be a sintered porous plastic filter, a fiber filter, a membrane, a screen, a carbon nanotube filter, a metal filter, a ceramic filter, or a non-woven filter, a combination thereof or any other porous filter known to one of ordinary skill in the art provided air flow may occur though the filter. The filtration medium prevents fluids and aerosolized droplets from passing through the filtration medium and into the pipetting device during a pipetting event.

In some embodiments the porous plastic filtration media may be made from sintered porous polyethylene, polypropylene, polyvinylidene fluoride (PVDF) or polytetrafluoroethylene (PTFE) materials or combinations thereof. Polyethylenes may be linear low density polyethylene, low density polyethylene, high density polyethylene, very high molecular weight polyethylene and ultrahigh molecular weight polyethylene. In a specific embodiment, polyethylene is very high molecular weight polyethylene or ultrahigh molecular weight polyethylene.

In some embodiments the porous plastic filtration media may be self-sealing upon contact with fluid or aerosol drops as described in US2008/0199363. In this embodiment, the porous plastic filtration media contains at least one absorbent material. In some embodiments, the at least one absorbent material is homogeneously dispersed throughout the porous plastic filtration media. In some embodiments, the at least one absorbent material comprises carboxymethylcellulose (CMC), cellulose gums, hydrolyzed acrylonitrile graft copolymer, neutralized starch-acrylic acid graft copolymer, acrylamide copolymer, modified crosslinked polyvinyl alcohol, neutralized self-crosslinking polyacrylic acid, crosslinked polyacrylate salts, or neutralized crosslinked isobutylene-maleic anhydride copolymers, or salts or mixtures thereof. Self-sealing, as used herein, refers to the ability of the absorbent material to substantially close or seal pores of the porous media such that the passage of liquid and/or aerosols is inhibited or prevented, thereby preventing contamination of the pipetting device. Not all the pores of the porous media are required to be substantially closed or sealed in order for the composition to be self-sealing. In some embodiments, absorbent materials comprise those described by U.S. Pat. Nos. 5,998,032; 5,939,086; 5,836,929, 5,824,328; 5,797,347; 5,750,585; 5,175,046; 4,820,577; 4,724,114; and 4,443,515. Examples of commercially available absorbent materials include AP80HS from Stockhousen of Tuscaloosa, Ala., HYSORB® P7200 from BASF of Florham Park, N.J., and CMC under the product designation C5013 and C5678 from Sigma-Aldrich of St. Louis, Mo.

In another embodiment, the porous plastic filtration media may contain a color change indicator to signal contact of the filtration media with fluid or aerosol drops as described in US2008/0199363. A color change indicator, according to embodiments of the present invention, is operable to at least partially change the color of the porous plastic filtration media when contacted with an aqueous and/or organic liquid, or aerosol drops. In some embodiments, the color change indicator changes the porous plastic filtration media from a first color to a second color when contacted with an aqueous and/or organic liquid or aerosol drops. In other embodiments, the color change indicator changes the porous plastic filtration media from colorless or white to colored. In a further embodiment, the color change indicator changes the porous plastic filtration media from a first shade of a color to a different shade of the same color. The color change of the porous plastic filtration media, according to embodiments of the present invention, depends on the identity of the color change indicator selected. In some embodiments, a color change indicator comprises an inorganic or organic dye, including food grade dyes, azo compounds, or azo dyes. In some embodiments, color change indicators do not comprise inorganic salts, including transition metal salts. In some embodiments, a color change indicator comprises FD & C Blue No. 1, FD & C Blue No. 2, FD & C Green No. 3, FD & C Red No. 40, FD & C Red No. 3, FD & C Yellow No. 5, FD & C Yellow No. 6, Solvent Red 24, Solvent Red 26, Solvent Red 164, Solvent Yellow 124, Solvent Blue 35, or combinations thereof.

The housing of the adapter must be sufficiently strong to be engaged by the pipetting device for insertion of the adapter into the pipette tip without breaking, cracking or substantially deforming the pipette tip or the housing of the adapter. In one embodiment, the adapter is inserted into the inside of the pipette tip by the pipetting device. In another embodiment, the adapter is inserted over the outside of the pipette tip by the pipetting device. In one embodiment, compressive forces are applied by the pipetting device to engage the adapter, and also to insert the adapter into the pipette tip. In another embodiment, the pipetting device may have a sectioned needle tip which is inserted into the adapter and following insertion, the sections open and the needle tip couples to the adapter. The needle tip later releases the adapter by closing its sections.

In some embodiments, a sealing means, such as an O-ring, may be employed on the outer wall of the adapter housing to provide a good seal between the adapter housing and the inner wall of the pipette tip. In some embodiments, the outer wall of the adapter housing may have an indentation, or groove, into which an O-ring may be placed.

In some embodiments, a sealing means, such as an O-ring, may be employed on the inner wall of the adapter housing to provide a good seal between the adapter housing and the outer wall of the pipetting devices. In some embodiments, the inner wall of the adapter may have an indentation, or groove, into which an O-ring may be placed.

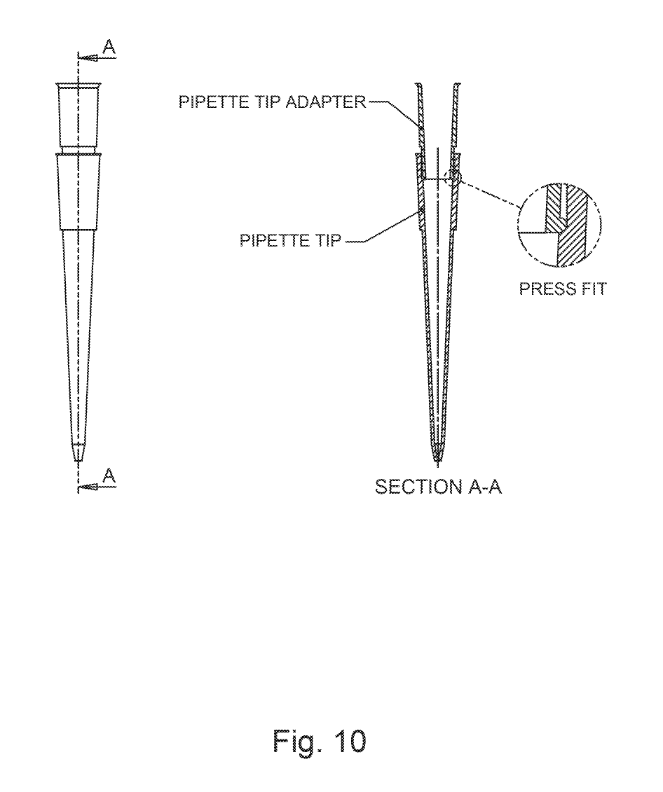

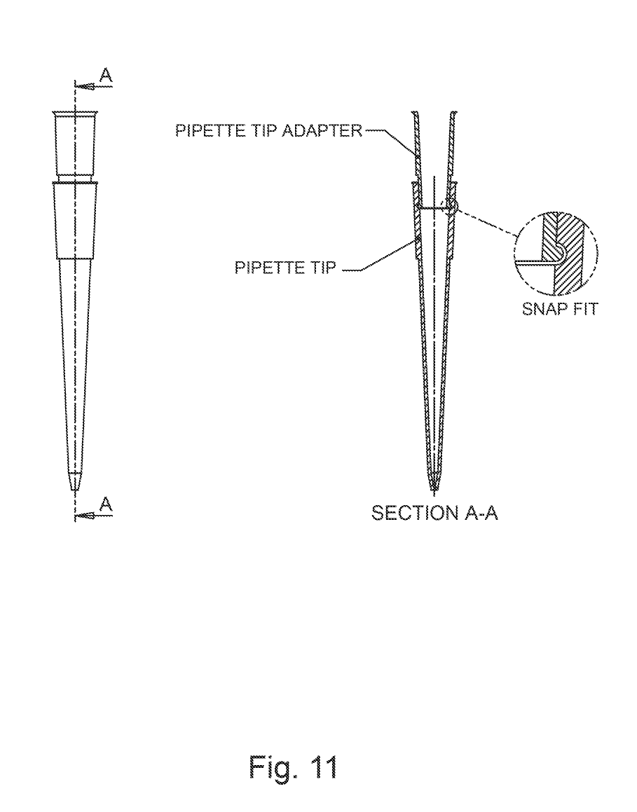

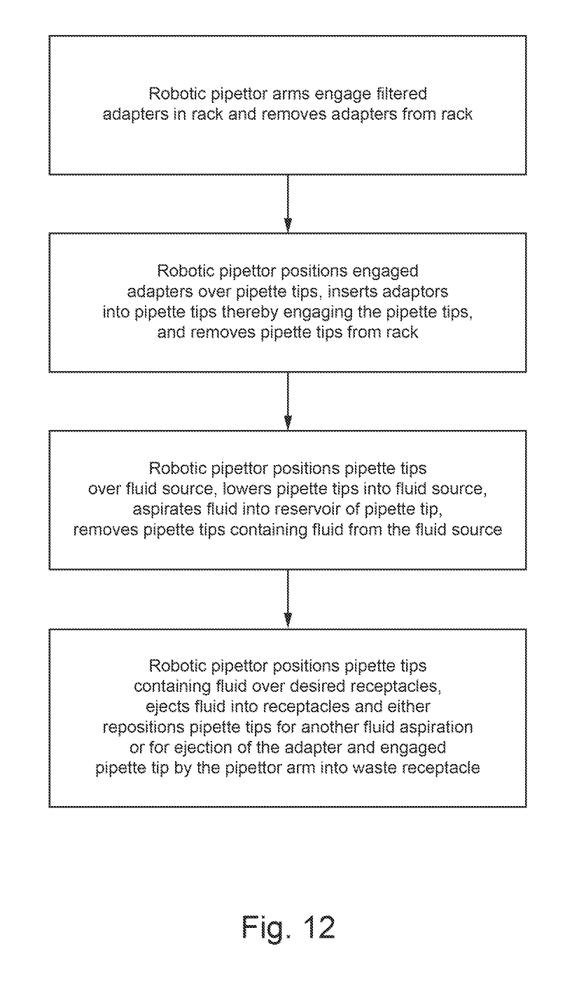

In some embodiments, the adapter may be molded in such a manner that the outer wall of the adapter contains a ridge that extends in a circular or ring-like manner around the outer wall of the adapter to provide a good seal between the adapter housing and a ledge on the inner wall of the pipette tip when the adapter is inserted into the pipette tip. See FIG. 10. In another embodiment, the inner wall of the pipette tip contains a groove or indentation that extends in a circular or ring-like manner in order to engage the ridge of the adapter to form a locking connection with the adapter when the adapter is inserted into the pipette tip. See FIG. 11. Such adapters may be made of plastic, rubber or other materials or other elastomeric materials such as thermoplastic elastomers.

In another embodiment, the adapter may be molded in such a manner that the inner wall of the adapter contains a ridge that extends in a circular or ring-like manner around the inner wall of the adapter to provide a good seal between the adapter housing and the outer wall of the pipette tip when the adapter is inserted onto or over the pipette tip. In this embodiment, the outer wall of the pipette tip contains a groove or indentation that extends in a circular or ring-like manner in order to engage the ridge of the adapter to form a locking connection with the adapter when the adapter is inserted onto or over the pipette tip. Such adapters may be made of plastic, rubber or other materials or other elastomeric materials such as thermoplastic elastomers.

In one embodiment, rubber materials may be polyisoprene or polybutadiene based materials. In another embodiment, materials could also be thermoplastic elastomers (TPE). TPEs include but are not limited to styrenic block copolymers, polyolefin blends, elastomeric alloys (TPE-v or TPV), thermoplastic polyurethanes, thermoplastic copolyester and thermoplastic polyamides. Examples of TPE products that are derived from block copolymers group are Arnitel (DSM), Engage (Dow chemical), Hytrel (Du Pont), Kraton (Shell chemicals), Pebax (Arkema), Pellethane, Riteflex (Ticona), Styroflex (BASF) and more. While there are now many commercial products of elastomer alloy, these include: Alcryn (Du Pont), Dryflex, Evoprene (AlphaGary), Forprene, Geolast (Monsanto), Mediprene, Santoprene and Sarlink (DSM).

In another embodiment the sealing means is an O-ring that provides an air tight seal between the pipette tip, the adapter and pipetting device.

In yet another embodiment, the coupling between the pipetting device and the adapter is a frictional fit.

The porous filtration medium in the adapter may be a sintered porous plastic filter, a fiber filter, a membrane, a screen, a carbon nanotube filter, a metal filter, a ceramic filter, or a non-woven filter, a combination thereof or any other porous filter known to one of ordinary skill in the art provided air flow may occur though the filter.

### Racks for Adapters

The racks housing the stacked adapters must be sufficiently strong to withstand the force applied by the pipetting device when the adapters are engaged in the rack by the pipetting device. Racks can hold a plurality of adapters. Each opening in a rack may contain one adapter. In another embodiment, adapters may be stacked on top of each other within a rack. Each opening in a rack may contain one adapter or 2, 3, 4, 5, 6, 7, 8, 9 or 10 stacked adapters.

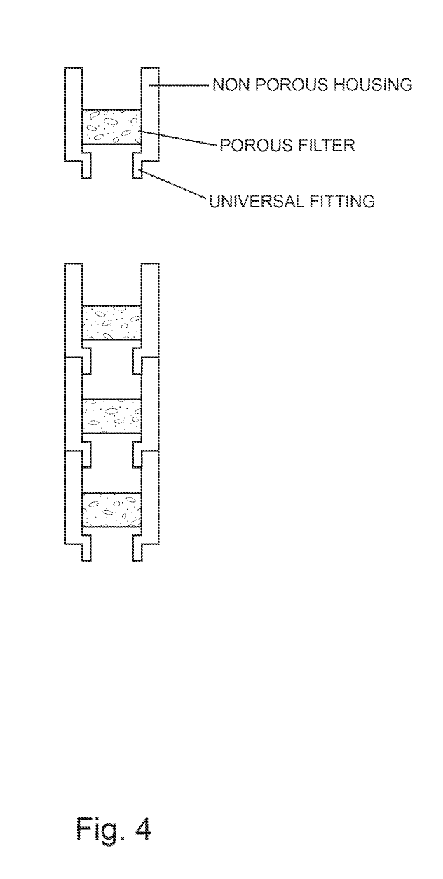

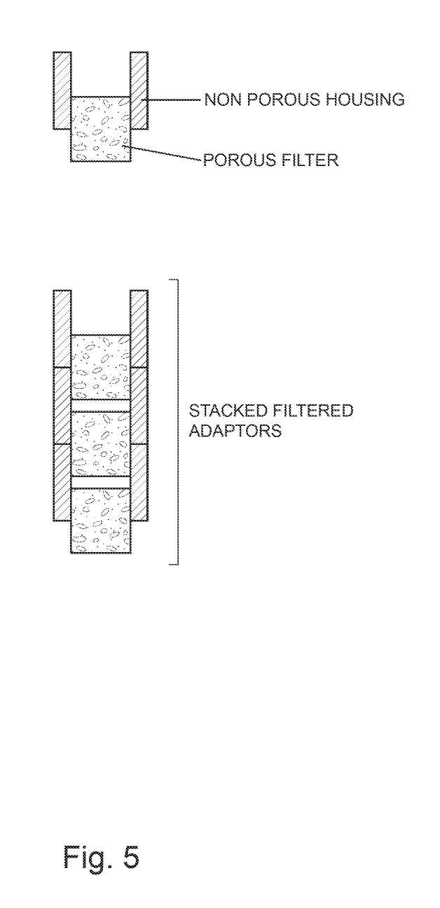

The base of the adapter which will contact the pipette tip is located below the opening in the rack for the adapter. In one embodiment, the adapter has a ledge which rests on the surface of the rack holding the adapter (FIG. 4). The base may be the housing when a housing is present. Alternatively the base may be the porous filtration medium as seen for example in FIG. 5.

In another embodiment, each rack contains one layer of adapters, with one adapter located in each opening in the rack. These racks may be stacked together so that the total height of the racks is less than the height of the all the adapters held in the racks.

### Pipette Tips

Any size pipette tip may be used to connect with the adapters of the present invention. For example, such pipette tips may be designed for volumes in the nanoliter (nl) to milliliter (ml) range, including but not limited to, 100 nl, 1 ul, 10 ul, 25 ul, 50 ul, 100 ul, 200 ul, 500 ul, 1 ml, 5 ml and 10 ml. Such pipette tips are commercially available.

In one embodiment, a pipette tip may contain a filter. In another embodiment, a pipette tip does not contain a filter.

In the embodiment wherein the pipette tip contains a filter, the combination of a filtered adapter with a filtered pipette tip provides enhances protection of the pipetting device from contaminating fluids or aerosolized droplets. In some embodiments wherein the pipette tip contains a filter, the filter may act as a solid phase extraction medium or another functional medium for absorption or binding of desired analytes in the fluid to be pipetted past the filter in the pipette tip and into the fluid reservoir of the pipette tip. Such functional media which may be employed in the filter include, but are not limited to, silica based materials such as C-4, C-8 or C-18 materials, ion exchange materials, controlled porous glass (CPG) and other adsorptive materials known to one of ordinary skill in the art.

In some embodiments, the inner wall of the pipette tip may have an indentation, or groove, into which an O-ring or a molded circumferential ridge on the outer wall of the adapter may fit when the adapter is placed into the pipette tip by the pipetting device. In other embodiments, the outer wall of the pipette tip may have an indentation, or groove, into which an O-ring or a molded circumferential ridge on the inner wall of the adapter may fit when the adapter is placed over or onto the pipette tip by the pipetting device.

### Rack for Pipette Tips

Racks housing the pipette tips must be sufficiently strong to withstand the force applied by the pipetting device when the adapters held by the pipetting device engage the pipette tips in the pipette tip rack. Racks are commercially available, for example from VWR (Radnor, Pa.) and Fisher Scientific (Hampton, N.H.).

Racks and methods of stacking pipette tips are known in the art, for example as disclosed in U.S. Pat. Nos. 5,366,088, 6,098,802, 6,534,015, 7,220,590 and US Patent Application Publication Nos: 2005/0150808 and 2005/0255005, and may be used in the present invention for pipette tips or adapters.

In one embodiment, racks can hold a plurality of pipette tips. Each opening in a rack may contain one pipette tip. In another embodiment, pipette tips may be stacked on top of each other within a rack. Each opening in a rack may contain one adapter or 2, 3, 4, 5, 6, 7, 8, 9 or 10 stacked pipette tips. In another embodiment, each rack contains one layer of pipette tips, with one pipette tip located in each opening in the rack. These racks may be stacked together so that the total height of the racks is less than the height of the all the pipette tips held in the racks.

### Pipetting Device

In one embodiment, the pipetting device is a manual pipetting device which can accommodate a plurality of pipetting arms which can engage a plurality of adapters containing filters for placement into a plurality of pipette tips. Such manual pipetting devices can achieve a plurality of simultaneous pipetting events and are commercially available from companies such as VWR (Radnor, Pa.), Oxford, and Gilson (Middleton, Wis.).

In another embodiment, the pipetting device is an automated or robotic pipetting device which can accommodate a plurality of pipetting arms or barrels which can engage a plurality of adapters containing filters for placement into a plurality of pipette tips. Automated pipetting devices are also called liquid handling devices in this application and the terms are used interchangeably. Such robotic pipetting devices can perform a plurality of simultaneous pipetting events, are used in high throughput situations and are commercially available from companies such as Innovadyne (Rohnert Park, Calif.), Eppendorf North America (Hauppauge, N.Y.), Hamilton (Reno, Nev.), Tecan (Männedorf, Switzerland), Roche (Indianapolis, Ind.), Beckman Coulter (Brea, Calif.).

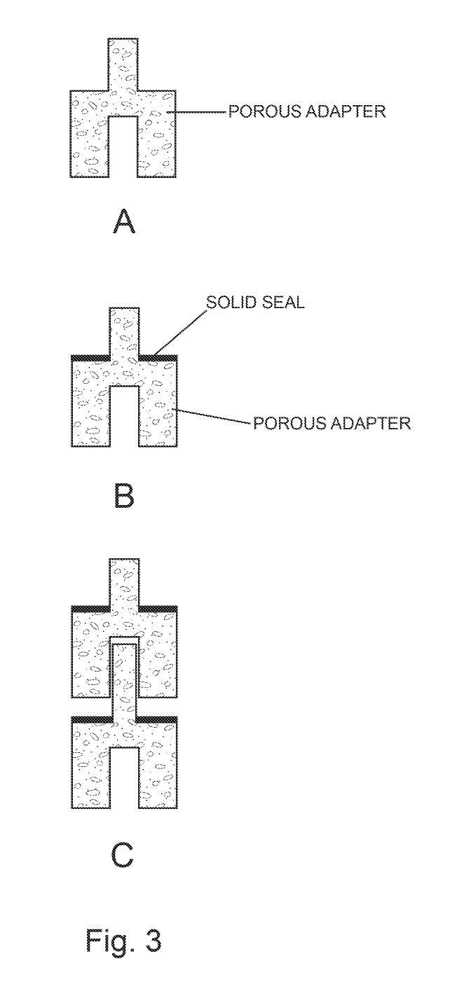

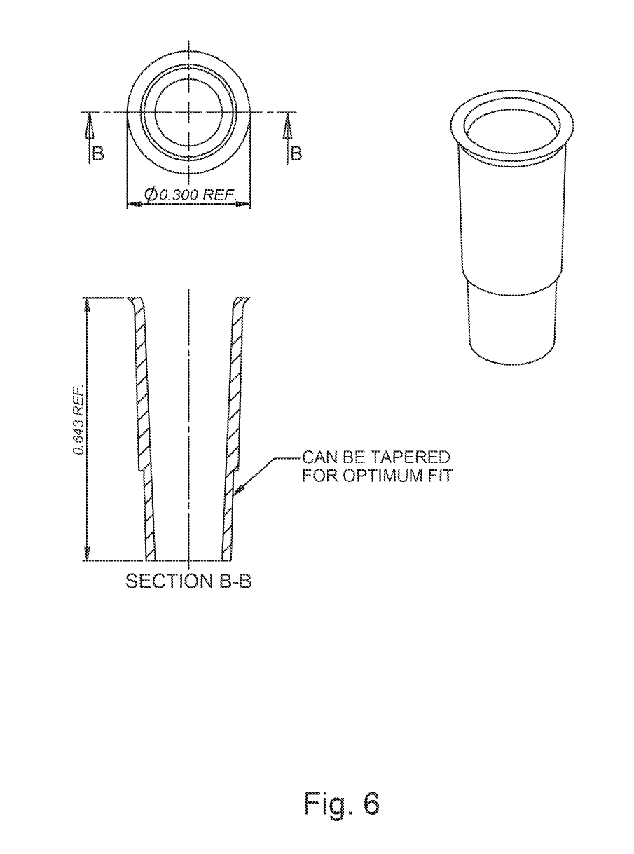

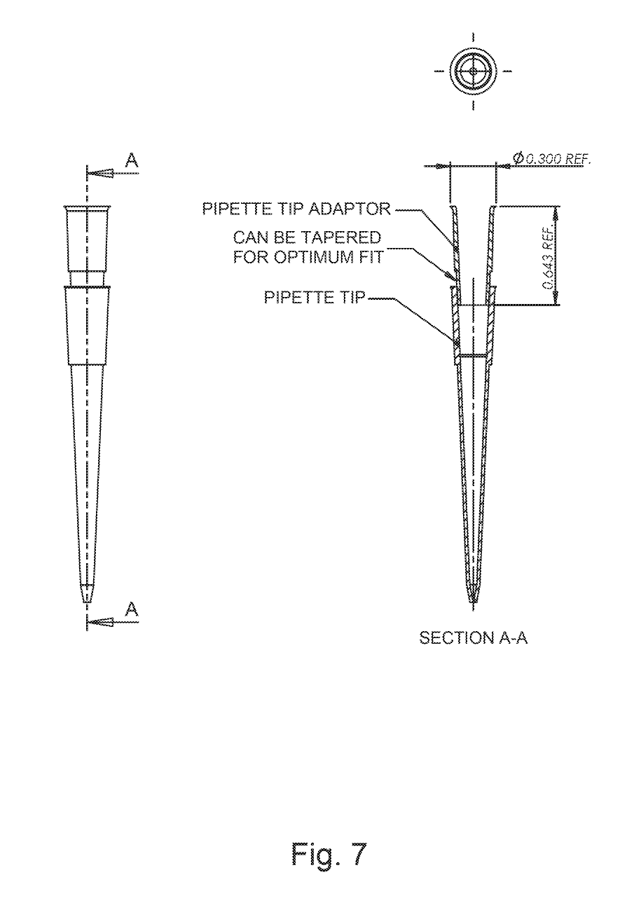

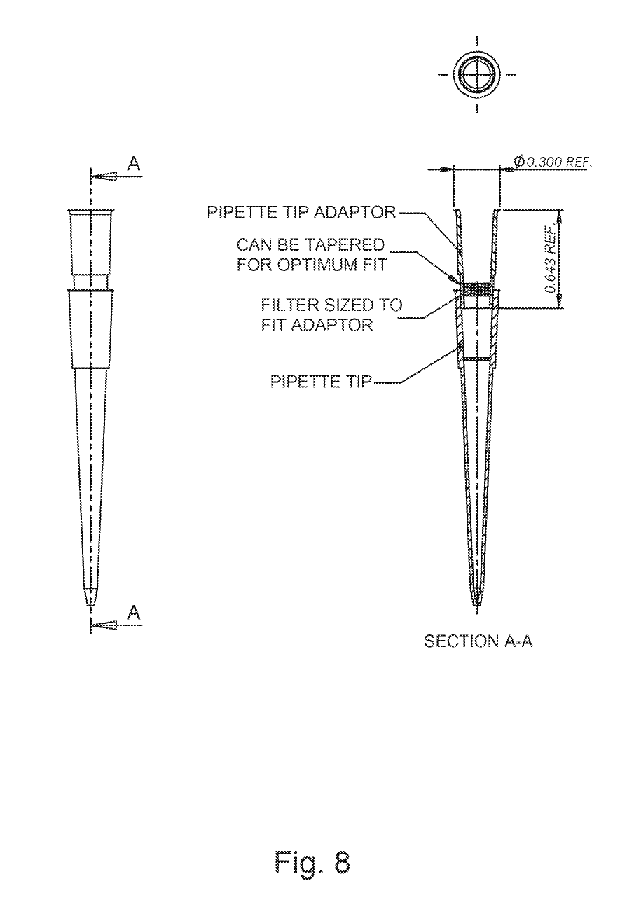

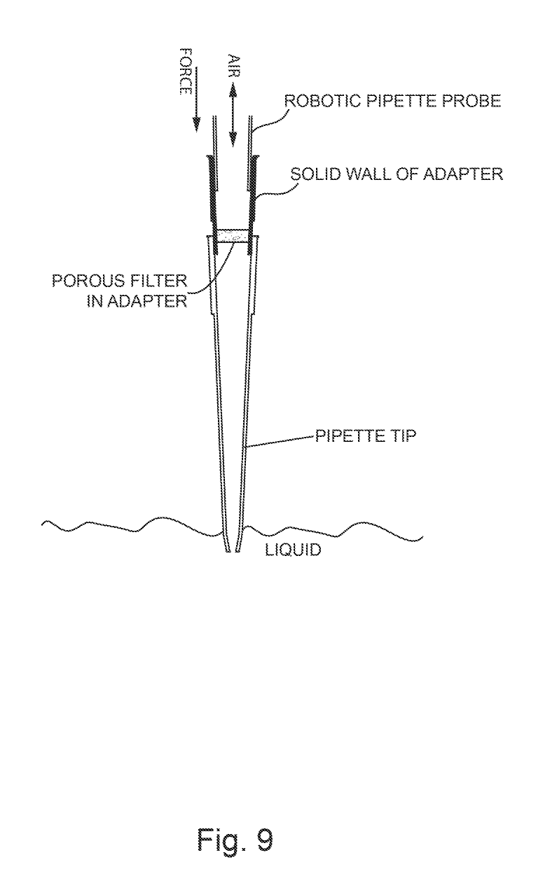

In one embodiment, the pipetting device may have a sectioned tip for use in engaging the adapter. Such sectioned tips may be similar to those shown in FIGS. 2, 3, 6, 8, and 9 of U.S. Pat. No. 6,039,485 and described therein.

The commercially available pipetting devices have means for ejecting pipette tips, adapters, and adapters engaged with pipette tips, to facilitate efficiency of robotic operations.

### System and Method of Operation

The system for using the adapter includes a pipetting device which in one embodiment is a programmable device with a plurality of pipetting arms or barrels, a rack of adapters containing filters for engaging the pipetting arm on one end of the adapter and removing the adapter from the rack, and a rack of pipette tips into which the pipetting arms lower the adaptor to engage the pipette tip at the second end of the adapter. Once the pipette tip is engaged by the adapter, the pipette tips are removed from the rack by the pipetting device, positioned over a desired location, for example a reservoir of fluid or a 96 well plate containing fluid, and lowered into the fluid. The pipetting device then applies suction to cause a selected amount of fluid to enter the liquid chamber of the pipette tip. This is followed by removal of the pipette tips from the fluid, positioning the tips containing fluid over a desired location, and ejecting the fluid into the desired location. Next, the pipette tips may be employed in a subsequent pipetting event. Alternatively, in a single use situation, the pipette tips with attached adapters may be ejected from the pipetting arm into a waste receptacle and a new set of adaptors may be engaged by the pipetting arms, followed by insertion of the adapters into a new set of pipette tips for a new pipetting event.

Receptacles to receive fluid from pipette tips include but are not limited to tubes (glass or plastic), cell culture plates and microplates. Microplates may have numerous wells, for example 6, 12, 24, 48, 96, 384, 1536, 3456 or 9600 sample wells arranged in a rectangular matrix.

In one embodiment, a pipetting device containing 96 pipettors and capable of performing 96 simultaneous pipetting events is employed. The pipetting device is programmed to engage 96 adapters containing filters in a rack, such that each one of the 96 pipettors engages a first end of one adapter. Next, the 96 pipettors with attached adapters are lifted up away from the rack containing the adapters, and positioned over 96 pipette tips in another rack. The 96 pipettors with attached adapters are then inserted into the pipette tips such that the second end of each adapter is inserted into a first opening of each pipette tip and engages the pipette tip. Next, the pipettors with attached adapters and pipette tips are lifted away from the pipette tip rack and the second end of each pipette tip is inserted into a reservoir containing a fluid, such as a cell culture fluid. A desired volume, for example 50 μl is drawn into each of the 96 pipette tips by the pipetting device. The pipette tips are then removed from the cell culture fluid and positioned over a 96 well plate containing cells, such that each pipette tip is located over one well. The 50 μl of cell culture fluid is then expelled by the pipettor from each pipette tip into the 96 wells containing the cells. This process is optionally repeated for a selected number of 96 well plates containing cells. When pipetting is completed, the pipette tips containing the adapters are ejected from the barrels of the pipettors and discarded. It is to be understood that the racks that contained the adapters, and the racks that contained the pipette tips are removed and may be subsequently stacked and stored for subsequent loading with new adapters or new pipette tips. The adapters containing the filters prevent contamination with the pipette barrels of the pipettors in the pipetting device.

In another embodiment similar to the previous embodiment, this system is used to pipette radioactive amino acids in cell culture fluid. In this embodiment, each adapter coupled to each pipette tip is used once. After ejection of the radioactive fluid into each well of the 96 well plate, the pipette tips and adapters are then positioned over a receptacle for radioactive waste and the radioactive pipette tips and attached adapters are discarded. Next, the pipetting device engages a second set or level of 96 adapters containing filters which were stacked on the first set of 96 adapters. These new adapters are then inserted into a second set or level of 96, 200 μl pipette tips contained in a rack that was stacked on the first rack of 200 μl pipette tips. Next the same pipetting steps are repeated. This process is optionally repeated for a selected number of 96 well plates containing cells.

The system and method can be used in single channel or multi-channel pipetting devices or liquid handling devices and works with all standard or customized trays or plates, such as 12, 24, 48, 96, 384, 1536 well plates.

There are many combinations of using filtered adapters with the filtered or unfiltered pipette tips depending on the assay protocol. Engaging the stacked filtered adapters and stacked long pipette tips together on the site of application provides significant savings in the space required to store such racks compared to individually stacked, filtered long pipette tips. It also significant reduces the cost by eliminating the unnecessary usage of filtered pipette tips by programming the pipetting machine to directly engage with the unfiltered pipette tips when the step requires pure water or buffers instead of aerosols that might contaminate the pipetting machine.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### EXAMPLE 1

### Elisa Assay

Step one: A pipetting device capable of performing 96 simultaneous pipetting events for 96-well plates is programmed to engage 96 pipettors into 96 adapters containing filters stacked in a first rack, remove the adapters from the first rack and insert them into 96, 200 μl pipette tips contained in a second rack. After insertion of the adapters into the pipette tips, the pipette tips with attached adapters are removed from the second rack by the pipetting device and are inserted into a reservoir containing a primary antibody immunoglobulin (IgG) fluid. A desired volume, for example 50 μl, is drawn into the 96 pipette tips by the pipetting device. The pipette tips are then removed from the primary antibody IgG fluid and positioned over a 96-well titer plate. The 50 μl of primary antibody IgG fluid is then expelled by the pipettor from each pipette tip into wells of the 96-well titer plate. After a preset time, the 50 μl of primary antibody IgG fluid are removed from wells of the 96-well titer plate with the same set of pipette tips and discharged together with the pipette tips and adapter. A new set of adapters and pipette tips can also be employed for removing the liquid from the 96-well titer plate.

Step two: The pipetting device engages 96 pipettors into the next layer of 96 adapters in the first rack and inserts them into the next layer of 96 pipette tips in the second rack. After insertion of the adapters into the pipette tips, the pipette tips with attached adapters are removed from the second rack and are inserted into a reservoir containing the analyte fluid. A desired volume, for example 50 μl, is drawn into the 96 pipette tips by the pipetting device. The pipette tips are then removed from the analyte fluid and positioned over a 96-well titer plate. The 50 μl of analyte fluid is then expelled from each pipette tip into individual wells of the 96-well titer plate. After a preset time, the 50 μl of the analyte fluid are removed from wells of the 96-well titer plate with the same set of pipette tips and discharged together with the pipette tips and adapter.

Step three: The pipetting device engages 96 pipettors into the next layer of 96 adapters in the first rack and inserts them into the next layer of 96 pipette tips in the second rack. After insertion of the adapters into the pipette tips, the pipette tips with attached adapters are removed from the second rack and are inserted into a reservoir containing the washing fluid. A desired volume, for example 100 μl, is drawn into the 96 pipette tips by the pipetting device. The pipette tips are then removed from the washing fluid and positioned over individual wells of a 96 well titer plate. The 100 μl of the washing fluid is then expelled from each pipette tip into individual wells of the 96-well titer plate. After a preset time, the 100 μl of the washing fluid are removed from wells of the 96-well titer plate with the same set of pipette tips and discarded together with the pipette tips and adapters. This process may be repeat several times depending on the required protocol.

Step four: The pipetting device engages 96 pipettors into the next layer of 96 adapters in the first rack and inserts them into the next layer of 96 pipette tips in the second rack. After insertion of the adapters into the pipette tips, the pipette tips with attached adapters are removed from the second rack and inserted into a reservoir containing the secondary antibody (anti-IgG) fluid. A desired volume, for example 50 μl, is drawn into the 96 pipette tips by the pipetting device. The pipette tips are then removed from the secondary antibody fluid and positioned over a 96-well titer plate. The 50 μl of the secondary antibody fluid is then expelled from each pipette tip into individual wells of the 96-well titer plate. After a preset time, the 50 μl of the secondary antibody fluid are removed from wells of the 96-well titer plate with the same set of pipette tips and discarded together with the pipette tips and adapter.

Step five: Repeat step three.

Step six: The pipetting device engages 96 pipettors into the next layer of 96 adapters in the first rack and inserts them into the next layer of 96 pipette tips in the second rack. After insertion of the adapters into the pipette tips, the pipette tips are removed from the second rack and are inserted into a reservoir containing the substrate fluid used to make a colored reaction product. A desired volume, for example 100 μl, is drawn into the 96 pipette tips by the pipetting device. The pipette tips are then removed from the substrate fluid and positioned over a 96 well titer plate. The 100 μl of the substrate fluid is then expelled from each pipette tip into individual wells of the 96-well titer plate. After a preset time, the 96-well titer plate is sent to a machine to read the densitometric result for each well.

### EXAMPLE 2

### Solid Phase Extraction

Step one: A pipetting device capable of performing 96 simultaneous pipetting events for 96 well plates is programmed to engage 96 pipettors into a layer of 96 adapters containing filters stacked in a first rack and insert them into a layer of 96, 200 μl unfiltered pipette tips stacked in a second rack. After insertion of the adapters into the pipette tips, the pipette tips with attached adapters are removed from the second rack and are inserted into a reservoir containing the extraction fluid. A desired volume, for example 50 μl, is drawn into the 96 pipette tips by the pipetting device. The pipette tips are then removed from the extraction fluid and positioned over a 3M Empore 96-well extraction filtered plate (3M, St. Paul, Minn.). The 50 μl of extraction fluid is then expelled from each pipette tip into each well of the 96-well extraction filtered plate. After a preset time, the 50 μl of extraction fluid are removed from the 96-well extraction filtered plate by vacuum and the pipette tips and attached adapters are ejected.

Step two: The pipetting device next engages the next layer of 96 unfiltered pipette tips, the pipette tips are removed from the second rack and are inserted into a reservoir containing the washing fluid. A desired volume, for example 100 μl, is drawn into the 96 pipette tips by the pipetting device. The pipette tips are then removed from the washing fluid and positioned over individual wells of a 96-well extraction plate. The 100 μl of the washing fluid is then expelled from each pipette tip into the 96 well extraction plate. After a preset time, the 100 μl of the washing fluid are removed from the 96-well extraction plate with vacuum and the same set of pipette tips can be used several times until the washing steps are completed.

All patents, publications and abstracts cited above are incorporated herein by reference in their entirety. It should be understood that the foregoing relates only to preferred embodiments of the present invention and that numerous modifications or alterations may be made therein without departing from the spirit and the scope of the present invention.

1.-14. (canceled)

15. An adapter for use with a pipetting device and a pipette tip comprising:
a deformable housing containing non-porous plastic or rubber walls surrounding a lumen;
a filter comprising a sintered porous plastic filter or a fiber filter, wherein the filter is located in the lumen in a manner to provide a barrier to fluid and aerosol.

16. The adapter of claim 15, wherein an inner wall of the adapter, an outer wall of the adapter, or both the inner wall and outer wall of the adapter contain a sealing means or a circumferential ridge.

17. The pipette tip of claim 16, wherein an inner wall of the pipette tip, an outer wall of the pipette tip, or both the inner wall and outer wall of the pipette tip contains a circumferential indentation or groove.

18. The adapter of claim 15, wherein the filter comprises a color change indicator.

19. The adapter of claim 15, wherein the filter comprises a self sealing additive.

20. The adapter of claim 15, wherein the sintered porous plastic in the filter is sintered porous polyethylene, polypropylene, PVDF or PTFE, or a combination thereof.

21. The adapter of claim 15, wherein the adapter is stackable.

22. A rack containing the adapter of claim 15.

23. The rack of claim 22, wherein the rack is stackable.

24. A method for performing automated pipetting comprising the sequential steps of:
A) employing a programmable automated pipetting device comprising a plurality of pipette barrels, each barrel operably connected on a first end to a suction means in the pipetting device, and having a second end with an opening;
B) providing a rack of adapters, each adapter containing a deformable plastic or rubber wall, a central lumen, a first end and a second end, the second end containing an opening, wherein the adapter comprises a filter selected from the group consisting of a sintered porous plastic filter and a fiber filter, wherein the filter is positioned in the lumen to provide a barrier to aerosols and liquids;
C) positioning the plurality of pipette barrels over the first ends of the adapters in the rack;
D) simultaneously contacting the second end of each pipette barrel with the first end of each adapter so that the pipette barrel and adapter are engaged;
E) removing the pipette barrels with attached adapters from the rack of adapters;
F) positioning the pipette barrels with attached adapters over a rack of pipette tips with or without filters, each tip having a first end and a second end, the first end having an opening of greater diameter than the second end, each adapter being positioned over the first end of each pipette tip;
G) simultaneously contacting the second end of each adapter with each pipette tip so that the adapter and pipette tip are engaged; and,
H) removing the pipette barrels with attached adapters and pipette tips from the rack of pipette tips.

25. The method of claim 24 further comprising the sequential steps of:
I) positioning the second end of each pipette tip over a fluid;
J) inserting the second end of each pipette tip into the fluid;
K) aspirating fluid into a reservoir of the pipette tip;
L) removing the pipette tips from the fluid;
M) positioning the pipette tips containing the fluid over a receptacle;
N) ejecting the fluid into the receptacle; and,
O) ejecting the adapters and attached pipette tips from the pipette barrels into a waste receptacle.

26. The method of claim 24, comprising repeating the steps A through H.

27. The method of claim 24, further comprising the sequential steps of:
I) positioning the pipette barrels over a rack of pipette tips with or without filters, each tip having a first end and a second end, the first end having an opening of greater diameter than the second end, each pipette barrel being positioned over the first end of each pipette tip;
J) simultaneously contacting the second end of each pipette barrel with the first end of each pipette tip so that the pipette barrel and pipette tip are engaged; and,
K) removing the pipette barrels with attached pipette tips from the rack of pipette tips.

28. The method of claim 27, further comprising the sequential steps of:
L) positioning the second end of each pipette tip over a fluid;
M) inserting the second end of each pipette tip into the fluid;
N) aspirating fluid into a reservoir of the pipette tip;
O) removing the pipette tips from the fluid;
P) positioning the pipette tips containing the fluid over a receptacle;
Q) ejecting the fluid into the receptacle; and,
R) ejecting the pipette tips from the pipette barrels into a waste receptacle.
